(19) United States
(12) Patent Application Publication
(10) Pub. No.: US 2022/0403891 A1
(43) Pub. Date: Dec. 22, 2022

(54) DRIVE DEVICE

(71) Applicant: PEGATRON CORPORATION, Taipei City (TW)

(72) Inventors: Wen-Hung Wang, Taipei City (TW); Pei-Chin Wang, Taipei City (TW)

(73) Assignee: PEGATRON CORPORATION, TAIPEI CITY (TW)

(21) Appl. No.: 17/676,733

(22) Filed: Feb. 21, 2022

(30) Foreign Application Priority Data
Jun. 17, 2021 (TW) 110122135

(51) Int. Cl. F16D 3/12; F16F 15/123; H02K 7/116; H02K 7/08; H02K 11/33

(52) U.S. Cl. CPC F16D 3/12; F16F 15/12313; H02K 7/116; H02K 7/08; H02K 11/33; F16F 2232/02; F16F 2236/08; B62M 6/45

(57) ABSTRACT

The disclosure provides a drive device including a gear, a bearing, and a motor rotor. The gear includes an installation hole. The bearing is disposed in the installation hole of the gear and includes a rotation hole, a sliding groove, and a drive assembly. The sliding groove communicates with the rotation hole, and the drive assembly is movably disposed in the sliding groove. The motor rotor rotatably passes through the rotation hole of the bearing. The drive assembly is moved to lock the bearing by the rotation of the motor rotor, and the torsion force of the motor rotor is transmitted to the gear through the bearing.

### CROSS-REFERENCE TO RELATED APPLICATION

This application claims the priority benefit of Taiwan applications serial no. 110122135, filed on Jun. 17, 2021. The entirety of the above-mentioned patent application is hereby incorporated by reference herein and made a part of this specification.

### BACKGROUND

### Technical Field

The present disclosure relates to a drive device, particularly to a drive device suitable for bikes.

### Description of Related Art

Currently, bikers can only activate the braking system by squeezing the handlebar to clamp the steel rings to rub against the front wheel and the rear wheel to slow the speed down or to stop the rotation of the wheels. However, the existing braking systems installed on bikes are prone to over-friction during rapid downhill braking, which may cause the braking system to heat itself up and fail, or cause serious wear and tear of the braking system under long-term use, thereby weakening its braking effect.

### SUMMARY

The present disclosure provides a drive device suitable for a bike and capable of bidirectional rotation, so as to assist accelerating and decelerating the bike.

The drive device of the disclosure includes a gear, a bearing and a motor rotor. The gear includes an installation hole. The bearing is disposed in the installation hole of the gear and includes a rotation hole, a sliding groove, and a drive assembly. The sliding groove communicates with the rotation hole, and the drive assembly is movably disposed in the sliding groove. The motor rotor rotatably passes through the rotation hole of the bearing, and the drive assembly is moved to lock the bearing by the rotation of the motor rotor, and the torsion force of the motor rotor is transmitted to the gear through the bearing.

In an embodiment of the disclosure, the drive assembly includes a first elastic member, a second elastic member, and a steel ball, and the sliding groove includes a first end and a second end opposite to each other. The first elastic member and the second elastic member are disposed respectively at the first end and the second end of the sliding groove. The steel ball is slidably disposed in the sliding groove and is located between the first elastic member and the second elastic member, and the steel ball contacts the motor rotor.

In an embodiment of the disclosure, when the motor rotor rotates in a first direction, the motor rotor drives the steel ball to compress the first elastic member and be fixed to the first end of the sliding groove to be locked to the bearing, and the torsion force of the motor rotor is transmitted to the gear through the bearing and drives the gear to rotate in the first direction.

In an embodiment of the disclosure, when the motor rotor rotates in a second direction, the motor rotor drives the steel ball to compress the second elastic member and be fixed to the second end of the sliding groove to be locked to the bearing, and the torsion force of the motor rotor is transmitted to the gear through the bearing and drives the gear to rotate in the second direction.

In an embodiment of the disclosure, when the motor rotor is stationary, the steel ball is restricted by the first elastic member and the second elastic member to be positioned in a central portion of the sliding groove.

In an embodiment of the disclosure, a width of the sliding groove is tapered from a central portion toward the first end and the second end. The width of the central portion is larger than the outer diameter of the steel ball, and the width of the first end and the width of the second end are smaller than the outer diameter of the steel ball.

In an embodiment of the disclosure, a controller is further included. The controller is coupled to the motor rotor for the motor rotor to switch to a forward rotation mode or a reverse rotation mode, or to turn off the motor rotor to switch to an idle mode.

In an embodiment of the disclosure, the motor rotor in the forward rotation mode continuously rotates in a first direction to assist in accelerating the gear.

In an embodiment of the disclosure, the motor rotor in the reverse rotation mode rotates intermittently in a second direction assist in decelerating the gear, and the rotation frequency of the motor rotor is multiple times per second.

In an embodiment of the disclosure, the bearing is flush with the outer surface of the gear.

Based on the above, the drive device of the disclosure is suitable for bikes, in which the motor rotor drives the drive assembly to be fixedly locked on the bearing and drives the gear, such that a torsion force of the motor rotor is transmitted to the gear through the bearing for deceleration or acceleration. When used for deceleration, the drive device of the disclosure reduces the frequency of using the brake system of the existing bike, prolonging the service life of the brake system.

### BRIEF DESCRIPTION OF THE DRAWING

FIG. 1 is a schematic perspective view of a drive device according to an embodiment of the disclosure.

FIG. 2 is a control block diagram of the drive device in FIG. 1.

FIG. 3 is a side plan view of the drive device in FIG. 1 switched to an idle mode or in a stationary state.

FIG. 4 is a side plan view of the drive device of FIG. 3 switched to a forward rotation mode.

FIG. 5 is a side plan view of the drive device of FIG. 3 switched to a reverse rotation mode.

### DESCRIPTION OF THE EMBODIMENTS

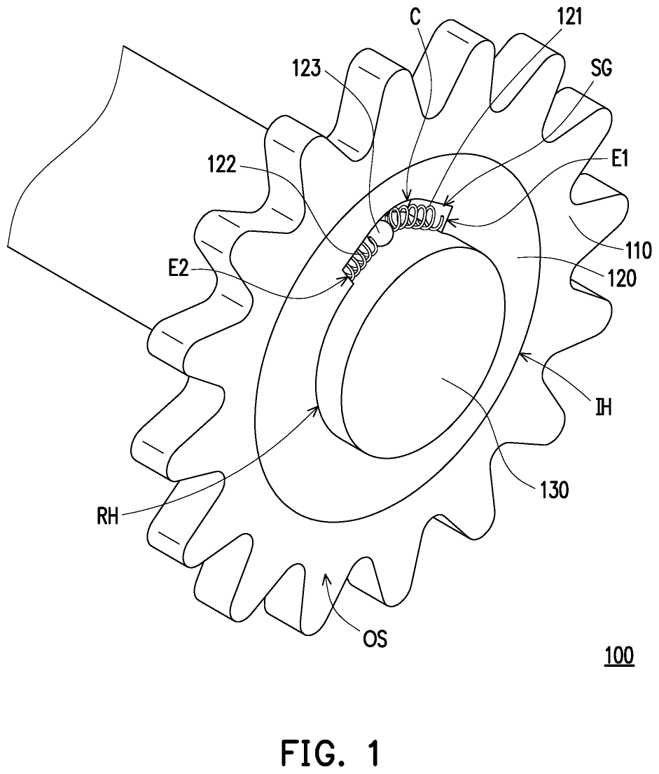

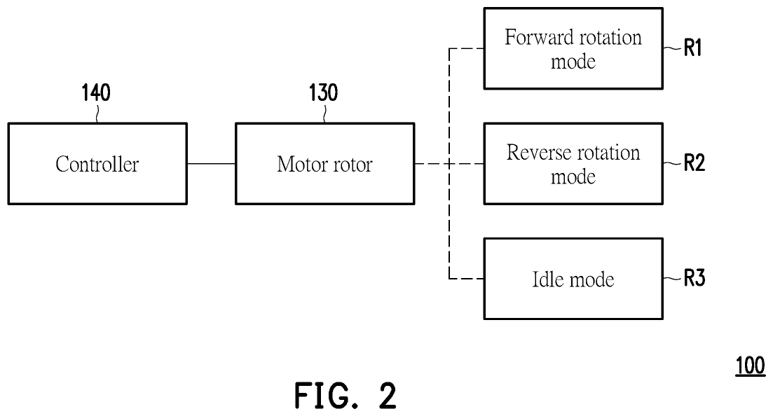

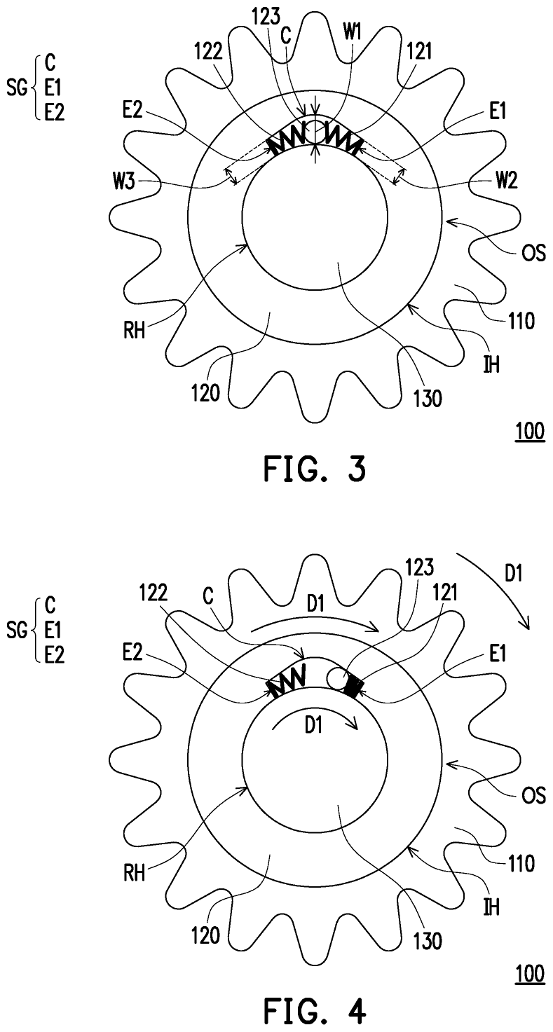

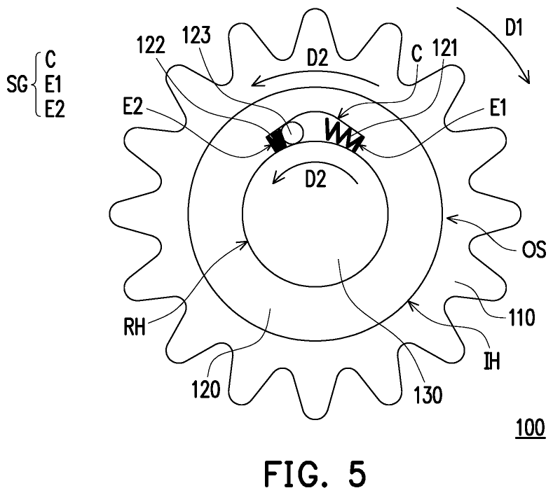

FIG. 1 is a schematic perspective view of a drive device according to an embodiment of the disclosure. FIG. 2 is a control block diagram of the drive device of FIG. 1. FIG. 3 is a side plan view of the drive device in FIG. 1 switched to an idle mode or in a stationary state. FIG. 4 is a side plan view of the drive device in FIG. 3 switched to a forward rotation mode. FIG. 5 is a side plan view of the drive device in FIG. 3 switched to a reverse rotation mode.

In FIG. 1 and FIG. 2, the drive device 100 of the present embodiment is suitable for a bike (not shown in the figure) and is adapted to connect the transmission structure of the bike.

The drive device 100 includes a gear 110, a bearing 120, and a motor rotor 130.

A bike refers to a vehicle that may be driven by human power, also known as a bicycle. There is usually no limit to the number of wheels on a bike, and it includes, for example, unicycles and vehicles with three wheels or more. Human powered vehicles include, for example, various types of bikes like mountain bikes, road bikes, city bikes, cargo bikes, and recumbent bikes.

The gear 110 includes an installation hole IH, and the installation hole IH passes through two outer side surfaces OS of the gear 110. The bearing 120 is disposed in the installation hole IH of the gear 110. The bearing 120 is fixedly connected to the inner edge surface of the installation hole IH, such that the bearing 120 is connected with the gear 110 as a whole and is suitable for synchronous rotation and torsion force transmission. Specifically, the bearing 120 includes a rotation hole RH, a sliding groove SG, and a drive assembly. The rotation hole RH passes through two sides of the bearing 120, and the sliding groove SG communicates with the rotation hole RH. The drive assembly is movably disposed in the sliding groove.

The motor rotor 130 rotatably passes through the rotation hole RH of the bearing 120, and the drive assembly is moved to lock the bearing 120 by the rotation of the motor rotor 130, such that a torsion force of the motor rotor 130 is transmitted to the gear 110 through the bearing 120. In addition, the motor rotor 130 is adapted to generate torsion force during rotation and drive the drive assembly to lock the bearing 120, and then transmit the torsion force from the bearing 120 to the gear 110.

Furthermore, in FIG. 1 and FIG. 3, the drive assembly of the bearing 120 includes a first elastic member 121, a second elastic member 122, and a steel ball 123. The sliding groove SG has a central portion C as well as a first end E1 and a second end E2 opposite to each other. The central portion C is located between the first end E1 and the second end E2. The first elastic member 121 and the second elastic member 122 are disposed respectively at the first end E1 and the second end E2 of the sliding groove SG, and the first elastic member 121 and the second elastic member 122 extend toward the central portion C of the sliding groove SG. The steel ball 123 is slidably disposed in the sliding groove SG and is located between the first elastic member 121 and the second elastic member 122.

In addition, initially, the steel ball 123 is restricted in the central portion C of the sliding groove SG and is positioned between the first elastic member 121 and the second elastic member 122. Since the sliding groove SG communicates with the rotation hole RH and that the motor rotor 130 passes through the rotation hole RH, the steel ball 123 of the sliding groove SG1 contacts the motor rotor 130.

Furthermore, the bearing 120 is flush with the outer surface OS of the gear 110, reducing the volume of the drive device 100.

In FIG. 3, the width of the sliding groove SG is tapered from the central portion C toward the first end E1 and the second end E2, meaning that the width of the sliding groove SG relative to the motor rotor 130 is not always the same. The width W1 of the central portion C of the sliding groove SG is larger than the outer diameter of the steel ball 123, and the width W2 of the first end E1 and the width W3 of the second end E2 of the sliding groove SG are smaller than the outer diameter of the steel ball 123.

In FIG. 3 to FIG. 5, the sliding groove SG of this embodiment allows the steel ball 123 to slide back and forth. When the steel ball 123 is driven by the motor rotor 130 to slide toward the first end E1 or the second end E2, since the width of the sliding groove SG gradually decreases from the central portion C to the first end E1 or the second end E2, the steel ball 123 is clamped in the sliding groove SG as it goes to where the width of the sliding groove SG is equal to the outer diameter of the steel ball 123.

In FIG. 3 to FIG. 5, the motor rotor 130 passes through the rotation hole RH of the bearing 120, and the steel ball 123 contacts the motor rotor 130. The motor rotor 130 may be switched to a forward rotation mode R1, a reverse rotation mode R2, or an idle mode R3 based on users' requirements. In the forward rotation mode R1, the motor rotor 130 rotates in a first direction D1 and drives the gear 110 to rotate in the first direction D1. In the reverse rotation mode R2, the motor rotor 130 rotates in a second direction D2 opposite to the first direction D1 and drives the gear 110 to rotate in the second direction D2. The motor rotor 130 is stationary in the idle mode R3.

In FIG. 3 and FIG. 4, when the motor rotor 130 rotates in the first direction D1 relative to the bearing 120 and the speed reaches a critical value, it drives the steel ball 123 to move in the first direction D1 and compress the first elastic member 121 to accumulate its elastic force. In addition, since the width of the sliding groove SG gradually decreases from the central portion C to the first end E1 and that the width W2 of the first end E1 is smaller than the outer diameter of the steel ball 123, the steel ball 123 is clamped at a position close to the first end E1 of the sliding groove SG, locking the motor rotor 130 to the bearing 120. At this time, the torsion force of the motor rotor 130 is transmitted to the gear 110 through the bearing 120 to drive the gear 110 to rotate in the first direction D1, that is, to switch to the forward rotation mode R1.

In FIG. 3 and FIG. 5, when the motor rotor 130 rotates in the second direction D2 relative to the bearing 120 and the speed reaches a critical value, the steel ball 123 is driven to move in the second direction D2 and compresses the second elastic member 122, and the elastic force of the second elastic member 122 is accumulated. In addition, since the width of the sliding groove SG gradually decreases from the central portion C to the second end E2 and that the width W3 of the second end E2 is smaller than the outer diameter of the steel ball 123, the steel ball 123 is clamped at a position close to the second end E2 of the sliding groove SG, locking the motor rotor 130 to the bearing 120. At this time, the torsion force of the motor rotor 130 is transmitted to the gear 110 through the bearing 120 to drive the gear 110 to rotate in the second direction D2, that is, to switch to the reverse rotation mode R2.

In FIG. 3, when the motor rotor 130 stops rotating, there is no torsion force to drive the steel ball 123 to move, and thus the steel ball 123 is restricted by the first elastic member 121 and the second elastic member 122 to be positioned in the central portion C of the sliding groove SG. Since the motor rotor 130 does not output any torsion force, the bearing 120 cannot be fixedly locked by the steel ball 123, so the gear 110 does not rotate and remains stationary. In another scenario, the gear 110 is driven by the external force exerted by the rider, and the gear 110 rotates relative to the motor rotor 130. Since the motor rotor 130 is stationary, the relative movement between the steel ball 123 and the motor rotor 130 does not affect the rotation of the gear 110.

As shown in FIG. 2, in an embodiment of the disclosure, the drive device 100 includes a controller 140. The controller 140 is coupled to the motor rotor 130 for starting the motor rotor 130 and for the motor rotor 130 to switch to the forward rotation mode R1 or the reverse rotation mode R2 based on users' requirements. The controller may also turn off the motor rotor 130 to switch to the idle mode R3. In one embodiment, the controller 140 is a physical switch, a touch handle, a button, a touch panel, etc. for the user to perform mode switching.

Please refer to both FIG. 2 and FIG. 4. In an embodiment of the disclosure, in which a bike is taken as an example, when the user steps on the pedal to drive the gear 110 connected to the bike to move forward, the rotation direction of the gear 110 is the same as the first direction D1. When the user activates the controller 140, the forward rotation mode R1 is selected, and the motor rotor 130 continuously rotates in the first direction D1 and transmits the torsion force to the gear 110 through the bearing 120 to drive the gear 110 to rotate in the first direction D1 for acceleration, thereby achieving the auxiliary acceleration function of the bike, increasing the speed of the bike.

Please refer to both FIG. 2 and FIG. 5. When the bike is going downhill or when the vehicle speed is too fast, the user activates the controller 140 to switch the drive device 100 to the reverse rotation mode R2, such that the motor rotor 130 rotates in the second direction D2 opposite to the first direction D1 of the gear 110 connected to the bike, and the torsion force is transmitted to the gear 110 through the bearing 120 to drive the gear 110 to rotate in the second direction D2, such that the gear 110 has the effect of stagnation, achieving the effect of deceleration braking to slow down the bike.

Furthermore, in the reverse rotation mode R2, the motor rotor 130 may rotate in the second direction D2 intermittently, and the frequency is about 3 times per second. Users can also increase the intermittent frequency of the reverse rotation of the motor rotor 130 according to the situation. When the motor rotor 130 intermittently rotates in the second direction D2, the gear 110 is intermittently driven to rotate in the second direction D2 intermittently, such that the gear 110 is intermittently stagnant.

Specifically, when the user activates the controller 140 to brake and decelerate, the controller 140 intermittently rotates the motor rotor 130 in the second direction D2, driving the gear 110 to also rotate in the second direction D2 intermittently to further drive the tire chain of the bike, causing the tire to stagnate intermittently to achieve the purpose of braking. Since the drive device of the disclosure has the function of intermittent continuous braking, and the intermittent reverse rotation time is very short, tire locking and slipping will not occur, improving the safety of the bike during the movement.

To sum up, the drive device of the disclosure is suitable for bikes, in which the motor rotor drives the drive assembly to be fixedly locked to the bearing and drives the gear, such that a torsion force of the motor rotor is transmitted to the gear through the bearing to achieve the effect of deceleration or acceleration. When used for deceleration, the drive device of the disclosure reduces the frequency of using the brake system of the existing bike.

Furthermore, when the drive device is switched to the forward rotation mode, the motor rotor is locked to the bearing and drives the gear to rotate in the first direction to assist in increasing the speed of the bike. When the drive device is switched to the reverse rotation mode, the motor rotor is locked to the bearing and drives the gear to rotate in the second direction to assist in reducing the speed of the bike. When the drive device is switched to the idle mode, the motor rotor and the gear rotate relative to each other, so the motor rotor does not affect the speed of the bike.

Furthermore, in the reverse rotation mode, the motor rotor is locked to the bearing and drives the gear to achieve the effect of deceleration, which avoids the failure of the braking system due to frictional heat.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A drive device suitable, comprising:
a gear comprising an installation hole;
a bearing, disposed in the installation hole of the gear and comprising a rotation hole, a sliding groove, and a drive assembly, wherein the sliding groove communicates with the rotation hole, and the drive assembly is movably disposed in the sliding groove; and
a motor rotor, rotatably passing through the rotation hole of the bearing, wherein the drive assembly is moved to lock the bearing by a rotation of the motor rotor, and a torsion force of the motor rotor is transmitted to the gear through the bearing.

2. The drive device as claimed in claim 1, wherein:
the drive assembly comprises a first elastic member, a second elastic member, and a steel ball; the sliding groove comprises a first end and a second end opposite to each other, the first elastic member and the second elastic member are disposed respectively at the first end and the second end; the steel ball is slidably disposed in the sliding groove and is located between the first elastic member and the second elastic member; and the steel ball contacts the motor rotor.

3. The drive device as claimed in claim 2, wherein when the motor rotor rotates in a first direction, the motor rotor drives the steel ball to compress the first elastic member and be fixed to the first end of the sliding groove to be locked to the bearing, and the torsion force of the motor rotor is transmitted to the gear through the bearing and drives the gear to rotate in the first direction.

4. The drive device as claimed in claim 2, wherein when the motor rotor rotates in a second direction, the motor rotor drives the steel ball to compress the second elastic member and be fixed to the second end of the sliding groove to be locked to the bearing, and the torsion force of the motor rotor is transmitted to the gear through the bearing and drives the gear to rotate in the second direction.

5. The drive device as claimed in claim 2, wherein when the motor rotor is stationary, the steel ball is restricted by the first elastic member and the second elastic member to be positioned in a central portion of the sliding groove.

6. The drive device as claimed in claim 2, wherein a width of the sliding groove is tapered from a central portion toward the first end and the second end, a width of the central portion is greater than an outer diameter of the steel ball, and a width of the first end and a width of the second end are smaller than the outer diameter of the steel ball.

7. The drive device as claimed in claim 1, further comprising a controller coupled to the motor rotor for the motor rotor to switch to a forward rotation mode or a reverse rotation mode, or to turn off the motor rotor to switch to an idle mode.

8. The drive device as claimed in claim 7, wherein in the forward rotation mode, the motor rotor continuously rotates in a first direction to assist in accelerating the gear.

9. The drive device as claimed in claim 7, wherein in the reverse rotation mode, the motor rotor rotates intermittently in a second direction to assist in decelerating the gear, and a rotation frequency of the motor rotor is multiple times per second.

10. The drive device as claimed in claim 1, wherein the bearing is flush with an outer side of the gear.
